(19) United States
(12) Patent Application Publication
(10) Pub. No.: US 2023/0186231 A1
(43) Pub. Date: Jun. 15, 2023

(54) CARBON COST LOGISTICS SYSTEM

(71) Applicant: Kyndryl, Inc., New York, NY (US)

(72) Inventors: Andrew S. KRONSTADT, Pensacola, FL (US); Joseph REYES, Holly Springs, NC (US); Marci Devorah FORMATO, Clintondale, NY (US); Bernhard Julius KLINGENBERG, Grover Beach, CA (US); Jennifer L. SZKATULSKI, Rochester, MI (US)

(21) Appl. No.: 17/546,301

(22) Filed: Dec. 9, 2021

(51) Int. Cl. G06Q 10/08

(52) U.S. Cl. CPC G06Q 10/087

(57) ABSTRACT

A carbon cost logistics system is provided which uses supply-chain-based data-analysis to determine, at least in part, a carbon logistics cost for each item of multiple items, and based on the determined carbon logistics costs, identifies a lowest carbon logistics cost item of the multiple items. The system further determines whether the lowest carbon logistics cost item of the multiple items meets one or more user-specified constraints, and based on the lowest carbon logistics cost item meeting the user-specified constraint(s), initiates an action to obtain the lowest carbon logistics cost item.

### BACKGROUND

This invention generally relates to logistics systems, and more specifically, the invention relates to facilitating carbon management in logistics systems.

An accelerating rate of change in the amount of trace gases in the Earth's atmosphere has the potential to modify the Earth's energy balance, which may result in a variety of consequences. These trace gases are often referred to as greenhouse gases and include carbon dioxide. Although there is disagreement concerning the potential threats or benefits of this change, there is widespread agreement in the global community that it is prudent to enact policies to attempt to slow down the rate of change. At the same time, research is underway to predict the consequences of increasing greenhouse gas concentrations and to develop technology to economically limit those increases. Current protocols have established emission reduction targets and define 1990 as the base year and specify reductions as a fractional percentage of emission rates during that base year.

Controlling energy consumption and carbon emission management in logistics (including product transportation and warehousing) is one aspect of green practices. Typically, logistics optimization only considers the direct monetary costs and other traditional performance measures, such as customer service. Optimal logistics policies can be significantly different from the inclusion of broader environmental costs, and constraints.

### SUMMARY

Certain shortcomings of the prior art are overcome and additional advantages are provided through the provision, in one or more aspects, of a computer program product for facilitating processing within a computing environment. The computer program product includes one or more computer-readable storage media having program instructions embodied therewith. The program instructions are readable by a processing circuit to cause the processing circuit to perform a method which includes using supply-chain-based data-analysis to determine, at least in part, a carbon logistics cost for each item of multiple items, and based on the determined carbon logistics costs, to identify a lowest carbon logistics cost item of the multiple items. Further, the method includes determining whether the lowest carbon logistics cost item of the multiple items meets one or more user-specified constraints, and based on the lowest carbon logistics cost item meeting the user-specified constraint(s), an action is initiated to obtain the lowest carbon logistics cost item.

Computer systems and computer-implemented methods relating to one or more aspects are also described and claimed herein. Further, services relating to one or more aspects are also described and may be claimed herein.

Additional features and advantages are realized through the techniques described herein. Other embodiments and aspects of the invention are described in detail herein and are considered a part of the claimed aspects.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 illustrates one embodiment of a product supply chain which can use or benefit from a carbon cost logistics system, in accordance with one or more aspects of the present invention;

FIG. 2 depicts one embodiment of a workflow illustrating certain aspects of one or more embodiments of the present invention;

FIG. 3 depicts a further example of a computing environment to incorporate and use one or more aspects of the present invention;

FIG. 4 illustrates another example of a computing environment to incorporate and use one or more aspects of the present invention;

FIG. 5 another embodiment of a workflow illustrating certain aspects of one or more embodiments of the present invention;

FIG. 6 illustrates another example of a workflow illustrating certain aspects of one or more embodiments of the present invention;

FIG. 7 depicts a further embodiment of a workflow illustrating certain aspects of one or more embodiments of the present invention;

FIG. 8A depicts yet another example of a computing environment to incorporate and use one or more aspects of the present invention;

FIG. 8B depicts further details of the memory of FIG. 8A, in accordance with one or more aspects of the present invention;

FIG. 9 depicts one embodiment of a cloud computing environment, in accordance with one or more aspects of the present invention; and

FIG. 10 illustrates one example of abstraction model layers, in accordance with one or more aspects of the present invention.

### DETAILED DESCRIPTION

The accompanying figures, which are incorporated in and form a part of this specification, further illustrate the present invention and, together with the detailed description of the invention, serve to explain aspects of the present invention. Note in this regard that descriptions of well-known systems, devices, Global Positioning Systems (GPS), digital transaction ledger technologies, such as blockchain, and other processing techniques, etc., are omitted so as to not unnecessarily obscure the invention in detail. Further, it should be understood that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further, that numerous inventive aspects and features are disclosed herein, and unless inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics or tools, only as examples, and not by way of limitation. Further, the illustrative embodiments are described in certain instances using particular hardware, software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

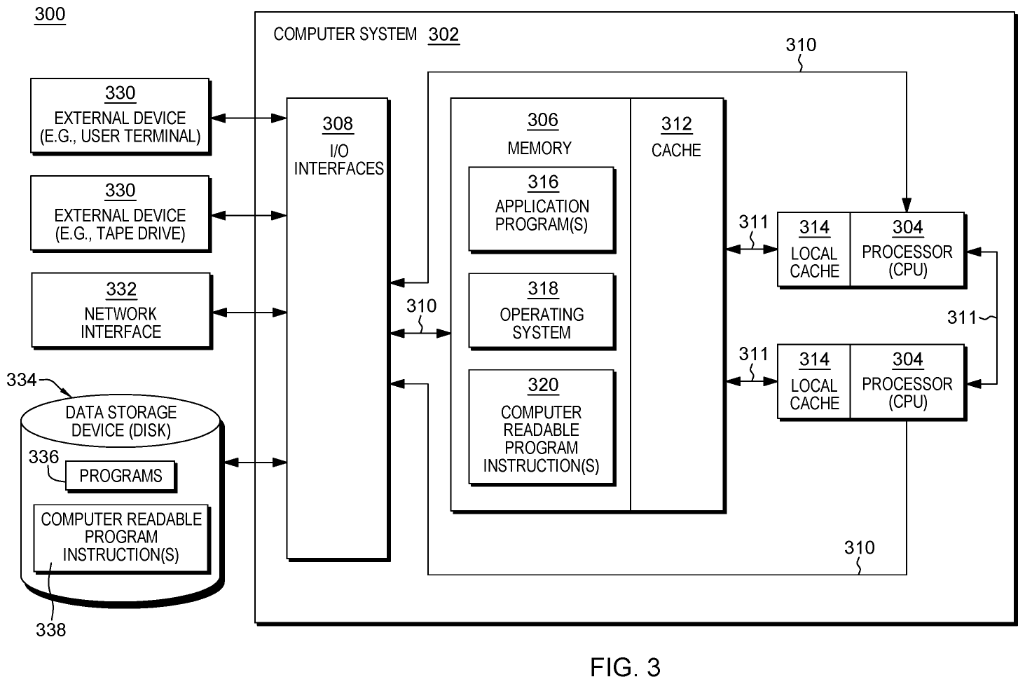

As understood by one skilled in the art, program code, as referred to in this application, can include both hardware and software. For example, program code in certain embodiments of the present invention can include fixed function hardware, but other embodiments can utilize a software-based implementation of the functionality described. Certain embodiments combine both types of program code. One example of program code, also referred to as one or more programs or program instructions, is depicted in FIG. 3 as one or more of application program(s) 316, application program interface(s) and computer-readable program instruction(s) 320, stored in memory 306 of computing environment 300, as well as programs 336 and computer-readable program instruction(s) 338, stored in a data storage device 334 accessed by, or within, computing environment 300.

As noted initially, existing logistics policies can be significantly different from, and omit inclusion of, broader environmental costs, and constraints. Controlling energy consumption and carbon emission management in logistics (including product transportation and warehousing) is one aspect of green practices addressed herein. Reducing carbon dioxide strategies exist, and applications are available for intelligent transport systems to allow for low-carbon transport from a manufacturer or a distributor perspective. However, there is no single end-to-end enterprise procurement system or method where a user can determine, and have flexibility options, whether to choose a least-carbon-cost path for any given purchased item, including selection of manufacturer, distributor, delivery methods, etc. Disclosed herein is an artificial intelligence (AI)-based logistics system which includes a carbon (e.g., carbon dioxide) end-to-end tracking system that is scalable to capture carbon logistics footprints. The carbon logistics systems and methods described herein can be leveraged for commercial use, where manufacturers can make use of real-time carbon cost data to determine a least-carbon path for product distribution, warehousing, delivery, etc.

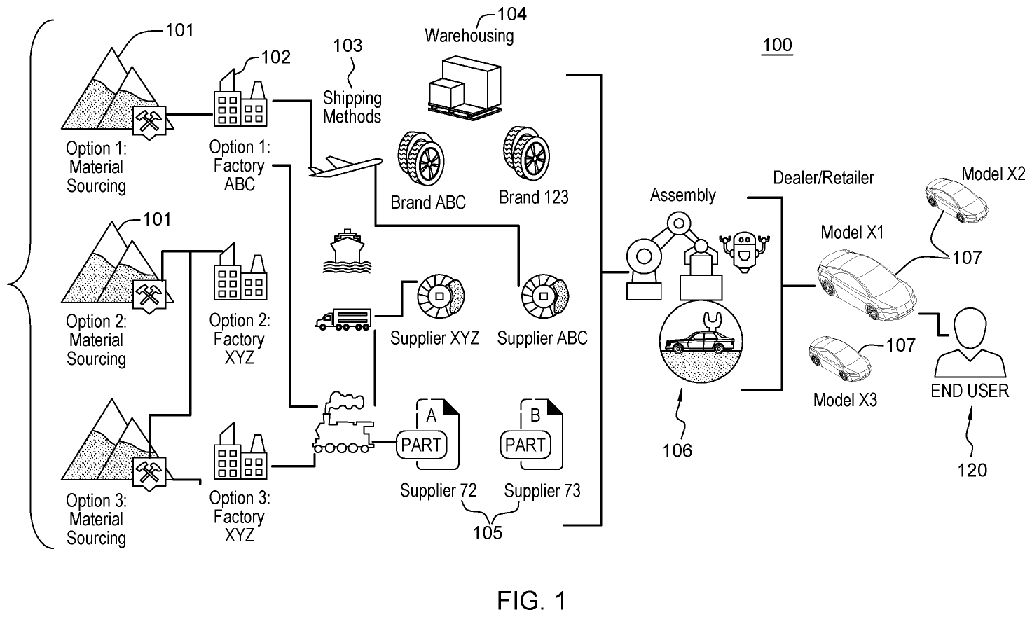

By way of example, FIG. 1 illustrates one embodiment of a product supply chain 100, for which carbon logistics cost can be determined and used, in accordance with one or more aspects of the present invention.

As illustrated in FIG. 1, a large number of entities and stages can be part of a product's supply chain, including multiple options for material sourcing 101, multiple options for component fabrication in different manufacturing factories 102, multiple shipping methods 103, multiple warehousing 104 and supplier 105 options, as well as the manufacturer or assembly entity 106, which provides to a dealer or retailer one or more variations or models of a product 107. As explained herein, in one or more implementations, a carbon cost logistics system and method such as disclosed can evaluate carbon logistics costs associated with one or more of the stages of the product supply chain to inform carbon cost decision making. For instance, in one embodiment, logistics can refer to warehousing and transport of items, and/or component(s) or material(s) used in fabricating the items. In one embodiment, carbon logistics costs can encompass substantially all aspects of the carbon cost associated with producing and/or distributing an item or product. With this information, a potential end-user 120 of an item can use the carbon logistics cost as a filter to, for instance facilitate selecting a particular item of multiple items which minimizes carbon costs while meeting one or more user-specified item-related constraints.

In one or more implementations, a data record (such as a blockchain record) can be provided or associated with each item and include transaction data, such as business-to-business data for the item, as well as carbon logistics-related data such as discussed herein. Due to supplier, vendor, logistics and other process differences, there can be multiple variants in a given item, as well as between models of an item, and between different manufacturers of items, particularly when analyzed down to the granular components, processes, and logistics steps throughout the supply chain ecosystem. Advantageously, the carbon logistics cost system (or engine) disclosed herein evaluates, in one or more embodiments, any of a variety of steps in the supply chain record data for an item, and facilitate selection and obtaining of a lowest carbon logistics cost item in a wide variety of environments.

As described herein, the carbon logistics cost system is, in one or more embodiments, an artificial intelligence (AI)-based system which aggregates available carbon cost data and uses the aggregated data to determine, for a given item, a carbon logistics cost for that item, as well as proposes similar items and determines carbon logistics costs for those similar items. In this manner, a user is presented, in one embodiment, with options to select an acceptable item which has, for instance, a lowest carbon logistics cost of multiple items evaluated. In one or more implementations, the lowest acquisition cost may therefore not be the deciding factor in sourcing a particular item for a user. The logistics system/engine disclosed herein can augment existing logistics systems and can include, in one or more embodiments, a data ingestion module, a data-analysis and decision module, and a logistics method module. In one implementation, relative carbon cost can be determined from manufacturer-to-receiver. This data can then be used, in one embodiment, to initiate change in vendors and/or delivery methods, as well as to determine carbon offsets between a selected (e.g., lowest acquisition cost item), and a lowest carbon cost item where different.

As described herein, there are a variety of potential implementations of a back-end carbon cost logistics system such as disclosed. For instance, the carbon cost logistics system can be configured as a commercial API-based system that interfaces with one or more automated procurement systems. In another embodiment, the carbon cost logistics system can include a consumer-based mobile application which communicates with a remote logistics system to provide, for instance, a consumer with a lowest carbon cost option for one or more items to be obtained. In a further embodiment, the carbon cost logistics system can be implemented with a browser add-on which assists in determining lowest carbon cost items under on-line consideration, and facilitates, where desired, in obtaining carbon offsets based on a given site and one or more shipping choices. In one or more implementations, the carbon cost logistics system can be a centralized system, such as a cloud-based system, with published application program interfaces which allow a user to access the system to aggregate product and inventory data and determine lowest carbon logistics costs from manufacturer to distributer to end-user for one or more items.

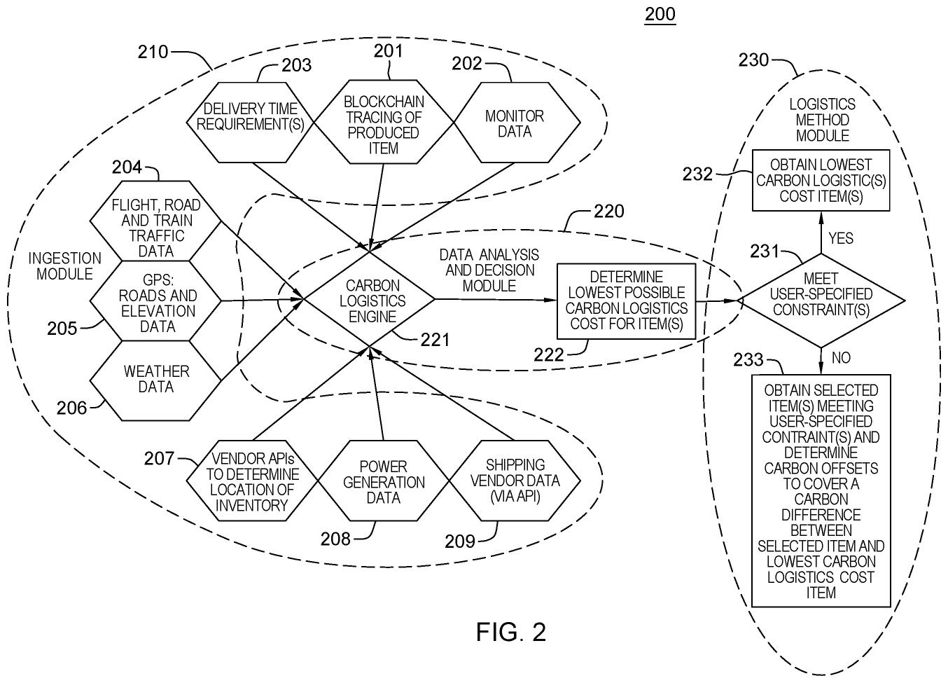

FIG. 2 depicts one embodiment of a workflow illustrating one or more embodiments of the present invention. In workflow 200 of FIG. 2, a data ingestion module 210, a data-analysis and decision module 220, and a logistics method module 230 are illustrated, by way of example. As depicted, in one embodiment, a carbon logistics engine (CLE) 221 receives ledger data, such as blockchain ledger data, of a produced item 201, as well as (optionally) monitor data 202 relating to, for instance, manufacture, transport, warehousing, etc., of the item, and any user-specified delivery time requirements or constraints 203. As known, recent developments in supply-chain management have lead to implementations of blockchain records for supply chain integrity assurance. Blockchain is a distributed method of managing a single immutable ledger of verified transactions. A blockchain ledger (interchangeably referred to herein as a “blockchain”) is decentralized, i.e., no single central authority is in control of the ledger entries or updates, but rather, a network of authorized members share and verify the records, or blocks, that are to be added to the ledger. Once added, a block is immutable, i.e., cannot be changed or deleted, before a block is committed to the ledger. In one or more implementations, carbon cost-related data such as discussed herein can be incorporated into the blockchain ledger for a particular supply chain, if desired.

Note that although discussed herein with reference to a blockchain ledger or record, the exemplary application described can be implemented in association with any available digital transaction ledger technology including, for instance, blockchain, cryptographic ledger, digital ledger, distributed ledger, hyper-ledger, replicated journal technology (RJT), etc.

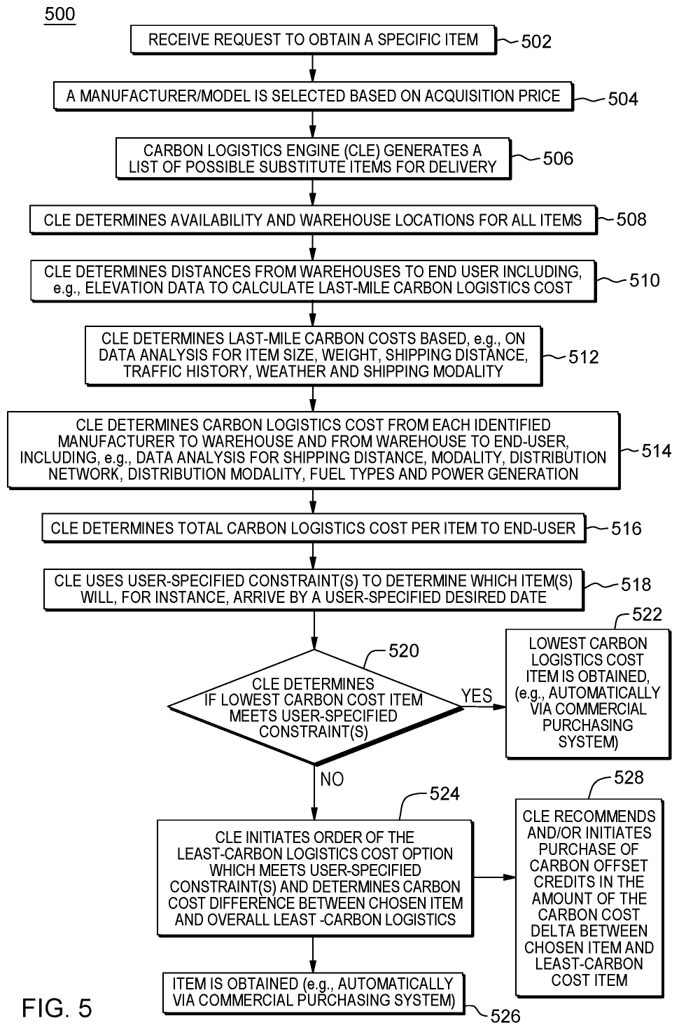

As illustrated in FIG. 2, ingested delivery-related data associated with transport of an item can further include flight, road and/or train traffic data 204, road and/or elevation data such as GPS-based data 205, weather data 206, as well as vendor APIs to determine location of item inventory 207, power generation data related to transport or warehousing of the item 208, as well as shipping vendor data (e.g., via an application program interface (API)) 209. As noted, in one or more embodiments, carbon logistics engine 221 includes program code which is configured to determine a lowest possible carbon logistics cost for one or more items 222, and uses the data in one or more workflows, such as described below with reference to FIGS. 5-7.

In the workflow of FIG. 2, an item with a lowest possible carbon logistics cost of multiple items can be compared to one or more user-specified constraints, such as one or more user-specified constraints (e.g., time of delivery, costs, etc.) 231, and if the lowest carbon logistics cost item meets the user-specified constraint(s), then logistics method module 230 can initiate obtaining the lowest carbon logistics cost item for the user 232. Otherwise, another item of the multiple items can be selected by the user that meets the user-specified constraint(s), and logistics method module 230 can determine a carbon offset to cover the carbon cost difference between the selected item and the lowest carbon cost item 233.

In one or more implementations, the carbon logistics cost system, and in particular, the data ingestion module, data-analysis and decision module (with the carbon logistics engine), and logistics method module, can be, or reside at, a remote, or centralized, computing environment, such as a cloud-based implementation, with one or more published APIs which aggregate product and inventory data, and determine the respective carbon logistics costs, for instance, from manufacturer to end-user for one or more items. In one embodiment, Markov Decision Processes (MDP) can be used in combination with neural network processing, such as Long Short-Term-Memory (LSTM) neural network processing, to iterate through each input data component, such as each time-based input component, and determine carbon costs associated with one or more logistics steps, as well as (in one embodiment) an optimal next step in the logistics process, routing towards a final total carbon cost, and final optimized decision endpoint. As each input component is added to the system sequentially, the logistics system is configured, in one embodiment, to determine the appropriate state to inform the final appropriate outcome and recommend, in one embodiment, carbon cost efficiency routes in the distribution decision process.

By way of further example, the data-analysis and decision module includes, in one embodiment, program code to process and analyze the ingested data, and provide an indication of an item of multiple items evaluated having the lowest carbon logistics cost. Using MDP and LSTM, the logistics system, in one embodiment, determines an optimal routing based on time and sequential input of data from the ingestion module, ascertaining the most efficient carbon steps towards the final outcome; decides based on prior steps and states of input at each state of analysis; and each input component can be evaluated for a given state, time, efficiency and system impact. For instance, as each system impact is recorded, the state/time/efficiency decision can be modified to compare against the ingested data. The optimal decision can be rooted in MDP/LSTM state/time efficiency determinations. The data processing can further include reinforcement learning to provide retrospective input into the holistic system to improve performance with each iteration. In one embodiment, the data-analysis and decision module can determine the “best decision route” for output in each successive iteration. Further, delivery method analysis can be included to inform values indicating lowest states based on input processing.

In one or more implementations, the carbon cost logistics system and method disclosed herein can be integrated with, for instance, a vendor system, or enterprise vendor system, to minimize the vendor's carbon consumption. Data and options analyzed can include location of warehouses, fuel types for end-user delivery (e.g., electric vehicles versus gasoline vehicles), distribution modalities (e.g., train delivery versus truck delivery), and enhanced services to end-users to provide more carbon tracking data and improve results in the carbon logistics engine for the end-users. In one or more embodiments, the carbon cost logistics system can be provided as a service offering, accessed by a paid subscription by, for instance, a vendor, distributor, end-user, etc. Advantageously, the carbon cost logistics systems disclosed herein facilitate identifying carbon offsets and purchasing the carbon offsets, when desired.

By way of example, in one implementation, the carbon cost logistics system and method can be aware of commercial distribution systems, warehouses, fuel efficiency, transport processes, last-minute delivery options, etc. For instance, the logistics system can determine that a refrigerated item to be delivered to Chicago would be less-optimally sourced from a warehouse in Arizona versus one in Montana, based on the carbon logistics cost to maintain temperature in transit. In one or more implementations, systems can interface with the carbon cost logistics system to provide item sourcing options as well as delivery options to a variety of manufacturers, distributors, suppliers, end-users, etc.

Disclosed herein, in one or more embodiments, are a computer program product, computer system and computer-implemented method which include, for instance, program code executing on one or more processors that uses supply-chain-based data-analysis to determine, at least in part, a carbon logistics cost for each item of multiple items, and based on the determined carbon logistics costs, identifies a lowest carbon logistics cost item of the multiple items. Further, the program code determines whether the lowest carbon logistics cost item of the multiple items meets one or more user-specified constraints, and based on the lowest carbon logistics cost item meeting the user-specified constraint(s), initiates an action to obtain the lowest carbon logistics cost item.

In one or more implementations, based on the lowest carbon logistics cost item not meeting the user-specified constraint(s), the method includes determining a carbon logistics cost difference between the lowest carbon logistics cost item and a selected item of the multiple items meeting the user-specified constraint(s), and initiating an action to obtain carbon offset credits equal to the carbon logistics cost difference between the selected item and the lowest carbon logistics cost item.

In one or more embodiments, determining the carbon logistics cost for each item of the multiple items includes using neural network processing and a Markov Decision Process to determine a respective carbon logistics cost for each item of the multiple items. In one example, the neural network processing includes Long Short-Term Memory (LSTM) neural network processing. In another embodiment, determining the carbon logistics cost for each item of the multiple items includes iterating through each time-based logistics component of multiple ascertained time-based logistics components to determine an optimal carbon-based next logistical step in a supply chain of the item.

In one embodiment, the method further includes identifying and including one or more items in the multiple items as potential substitute items for an initially-specified item, where the initially-specified item is another item of the multiple items. For instance, identifying the one or more items for including in the multiple items can be based on receiving a user-specified input identified the initially-specified item.

In one embodiment, using supply-chain-based data-analysis includes, at least in part, Global Positioning System (GPS) logistics data for an item of the multiple items in determining the carbon logistics cost for that item.

In one or more other embodiments, using supply-chain-based data-analysis includes using, at least in part, logistics data for an item of the multiple items representative of carbon delivery cost based on item size, item weight, shipping distance, and shipping modality.

Embodiments of the present invention are inextricably tied to computing and provide significantly more than existing approaches to logistics systems. For instance, embodiments of the present invention provide program code executing on one or more processors to exploit the interconnectivity of various systems, as well as to utilize various computing-centric data analysis and handling techniques, in order to ascertain a carbon logistics cost for each item of multiple items under consideration, as well as to determine a carbon offset to cover any carbon difference between a selected item of the multiple items, and a lowest carbon logistics cost item of the multiple items. Both the interconnectivity of devices and computing systems utilized, and the computer-exclusive data processing techniques utilized by the program code, enable various aspects of the present invention. Further, embodiments of the present invention provide significantly more functionality than existing approaches to managing product logistics.

In embodiments of the present invention, program code executing on one or more processors provide significantly more functionality, including but not limited to: 1) program code that uses supply-chain-based data-analysis to determine, at least in part, a carbon logistics cost for each item of multiple items; 2) program code that identifies, based on the determined carbon logistics costs, a lowest carbon logistics cost item of the multiple items; 3) program code that determines whether the lowest carbon logistics cost item of the multiple items meets one or more user-specified constraints; and 4) program code that initiates, based on the lowest carbon logistics cost item meeting the user-specified constraint(s), an action to obtain the lowest carbon logistics cost item.

Advantageously, the carbon cost logistics system and method disclosed herein improve processing within the computing environment by further facilitating implementing green practices within distribution of an item or product. Advantageously, end-to-end carbon analysis is facilitated by the logistics system processing disclosed. In one or more embodiments, delivery paths can by dynamically selected or configured from manufacturer or distributor to an end-user, based on carbon logistics costs. The logistic system automatically ingests data and analyzes the data to enhance carbon intelligence, and thereby reduce carbon consumption during transportation and warehousing of items or products. In one implementation, the logistics system provides greater insight into the final delivery leg of an item to an end-user.

As disclosed herein, the logistics system can be embodied in a variety of implementations. In one or more implementations, the carbon cost logistics system is an automated data ingestion and analysis system with application program interfaces (APIs) that can be used to provide end-user recommendations and actions. In one or more implementations, the carbon cost logistics system can be integrated with one or more enterprise procurement systems to facilitate automated obtaining of items based, at least in part, on carbon costs. In one embodiment, the logistics system can consider real-time weather or transport system failures (e.g., heatwave, blizzard, train derailment, bridge collapse, political/social unrest, etc.) in determining carbon costs, unlike other systems, which use non-dynamic carbon values. Disclosed herein, in one embodiment, is a global real-time carbon (e.g., carbon dioxide) logistics backend data-analysis system. The system can be used to reconfigure any or all of a supply chain (e.g., from manufacturing to transportation, to warehousing, to office operations, to final delivery methods, etc.), particularly focusing on delivery paths, and can adjust dynamically for conditions, from a manufacturer or warehouser, to the end-user, based on real-time data, as well as historical data and external variables, and projected carbon dioxide emission waste.

In another embodiment, the system provides automated recommendations on a per-item and/or per-order basis. On a per-item basis, the system can use user-specified constraints or requirements (e.g., delivery-time requirements, global carbon targets, or per-user carbon limits, etc.) and real-time data to decide between, for instance, modifying an order (e.g., changing vendor, warehouse, shipping modality), or obtaining carbon offsets between a selected item and the lowest possible carbon cost item determined. On a per-order basis, the carbon cost logistics system can determine, based on data-analysis, efficiency gains (e.g., single vehicle, single delivery, etc.) to ensure that the lower-carbon acquisition does not increase overall costs (e.g., dock availability, delivery management, inventory control, temporary warehousing, etc.).

One embodiment of a computing environment to incorporate and use one or more aspects of the present invention is described with reference to FIG. 3. As an example, the computing environment is based on the IBM® z/Architecture® instruction set architecture, offered by International Business Machines Corporation, Armonk, N.Y. One embodiment of the z/Architecture instruction set architecture is described in a publication entitled, “z/Architecture Principles of Operation,” IBM Publication No. SA22-7832-12, Thirteenth Edition, September 2019, which is hereby incorporated herein by reference in its entirety. The z/Architecture instruction set architecture, however, is only one example architecture; other architectures and/or other types of computing environments of International Business Machines Corporation and/or of other entities may include and/or use one or more aspects of the present invention. z/Architecture and IBM are trademarks or registered trademarks of International Business Machines Corporation in at least one jurisdiction.

Referring to FIG. 3, a computing environment 300 includes, for instance, a computer system 302 shown, e.g., in the form of a general-purpose computing device. Computer system 302 can include, but is not limited to, one or more general-purpose processors or processing units 304 (e.g., central processing units (CPUs)), a memory 306 (a.k.a., system memory, main memory, main storage, central storage or storage, as examples), and one or more input/output (I/O) interfaces 308, coupled to one another via one or more buses and/or other connections. For instance, processors 304 and memory 306 are coupled to I/O interfaces 308 via one or more buses 310, and processors 304 are coupled to one another via one or more buses 311.

Bus 311 is, for instance, a memory or cache coherence bus, and bus 310 represents, e.g., one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

As examples, one or more special-purpose processors (e.g., neural network processors) (not shown) can also be provided separate from but coupled to the one or more general-purpose processors and/or can be embedded within the one or more general-purpose processors. Many variations are possible.

Memory 306 can include, for instance, a cache 312, such as a shared cache, which may be coupled to local caches 314 of processors 304 and/or to neural network processor, via, e.g., one or more buses 311. Further, memory 306 can include one or more programs or applications 316 and at least one operating system 318. An example operating system includes on IBM® z/OS® operating system, offered by International Business Machines Corporation, Armonk, N.Y. z/OS is a trademark or registered trademark of International Business Machines Corporation in at least one jurisdiction. Other operating systems offered by International Business Machines Corporation and/or other entities may also be used. Memory 306 can also include one or more computer readable program instructions 320, which can be configured to carry out functions of embodiments of aspects of the present invention.

Moreover, in one or more embodiments, memory 306 can include processor firmware (not shown). Processor firmware can include, e.g., the microcode or millicode of a processor. It can include, for instance, the hardware-level instructions and/or data structures used in implementation of higher level machine code. In one embodiment, it includes, for instance, proprietary code that is typically delivered as microcode or millicode that includes trusted software, microcode or millicode specific to the underlying hardware and controls operating system access to the system hardware.

Computer system 302 can communicate via, e.g., I/O interfaces 308 with one or more external devices 330, such as a user terminal, a tape drive, a pointing device, a display, and one or more data storage devices 334, etc. A data storage device 334 can store one or more programs 336, one or more computer readable program instructions 338, and/or data, etc. The computer readable program instructions may be configured to carry out functions of embodiments of aspects of the invention.

Computer system 302 can also communicate via, e.g., I/O interfaces 308 with network interface 332, which enables computer system 302 to communicate with one or more networks, such as a local area network (LAN), a general wide area network (WAN), and/or a public network (e.g., the Internet), providing communication with other computing devices or systems.

Computer system 302 can include and/or be coupled to removable/non-removable, volatile/non-volatile computer system storage media. For example, it can include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 302. Examples, include, but are not limited to: microcode or millicode, device drivers, redundant processing units, external disk drive arrays, RAID systems, tape drives, and data archival storage systems, etc.

Computer system 302 can be operational with numerous other general-purpose or special-purpose computing system environments or configurations. Examples of well-known computing systems, environments, and/or configurations that are suitable for use with computer system 302 include, but are not limited to, personal computer (PC) systems, mobile devices, GPS-based devices, handheld or laptop devices, server computer systems, thin clients, thick clients, multiprocessor systems, microprocessor-based systems, set top boxes, programmable consumer electronics, network PCs, minicomputer systems, mainframe computer systems, and distributed cloud computing environments that include any of the above systems or devices, and the like.

In one example, a processor (e.g., processor 304) includes a plurality of functional components (or a subset thereof) used to execute instructions. These functional components can include, for instance, an instruction fetch component to fetch instructions to be executed; an instruction decode unit to decode the fetched instructions and to obtain operands of the decoded instructions; one or more instruction execute components to execute the decoded instructions; a memory access component to access memory for instruction execution, if necessary; and a write back component to provide the results of the executed instructions. One or more of the components can access and/or use one or more registers in instruction processing. Further, one or more of the components may (in one embodiment) include at least a portion of or have access to one or more other components used in performing neural network processing (or other processing that can use one or more aspects of the present invention), as described herein. The one or more other components can include, for instance, a neural network processing assist component (and/or one or more other components).

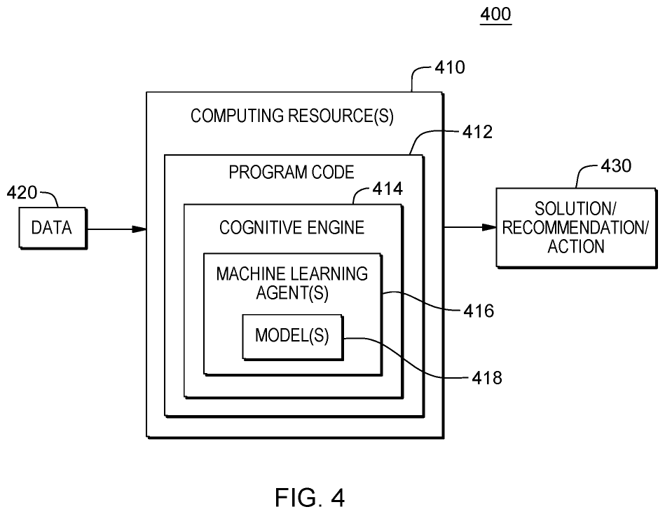

FIG. 4 depicts a further embodiment of a computing environment or system 400, incorporating, or implementing, certain aspects of an embodiment of the present invention. In one or more implementations, system 400 can be part of a computing environment, such as computing environment 300 described above in connection with FIG. 3. System 400 includes one or more computing resources 410 that execute program code 412 that implements a cognitive engine 414, which includes one or more machine-learning agents 416, and one or more machine-learning models 418. Data 420, such as the data discussed herein, is used by cognitive engine 414, to train model(s) 418, to (for instance) predict one or more parameters of a traffic-effecting event, and to generate one or more solutions, recommendations, actions 430, etc., based on the particular application of the machine-learning model. In implementation, system 400 can include, or utilize, one or more networks for interfacing various aspects of computing resource(s) 310, as well as one or more data sources providing data 420, and one or more systems receiving the predicted geographic location and/or the output solution, recommendation, action, etc., 430 of machine-learning model(s) 418. By way of example, the network can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including training data for the machine-learning model, predicted traffic event and an output solution, recommendation, action, of the machine-learning model, such as discussed herein.

In one or more implementations, computing resource(s) 410 houses and/or executes program code 412 configured to perform methods in accordance with one or more aspects of the present invention. By way of example, computing resource(s) 410 can be a traffic management system server, or other computing-system-implemented resource(s). Further, for illustrative purposes only, computing resource(s) 410 in FIG. 4 is depicted as being a single computing resource. This is a non-limiting example of an implementation. In one or more other implementations, computing resource(s) 410, by which one or more aspects of machine-learning processing such as discussed herein are implemented, could, at least in part, be implemented in multiple separate computing resources or systems, such as one or more computing resources of a cloud-hosting environment, by way of example.

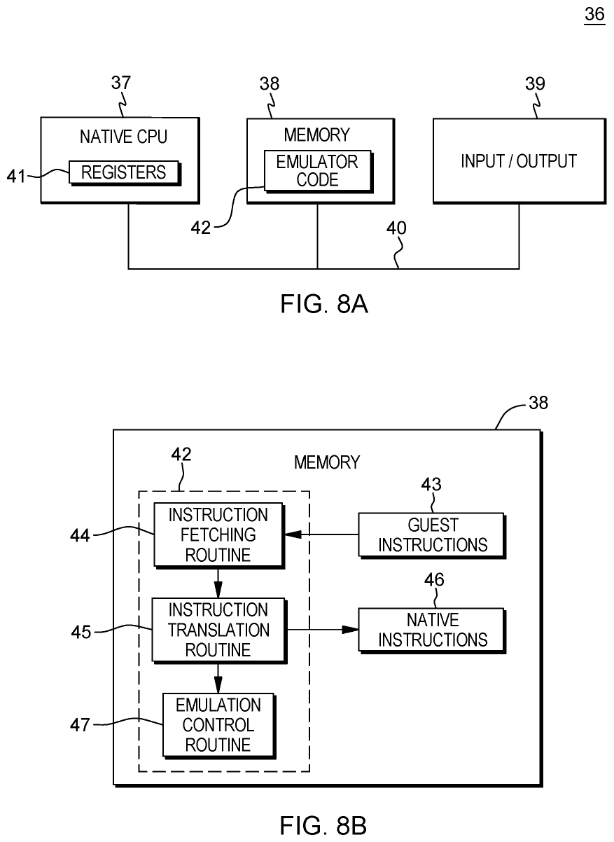

Briefly described, in one embodiment, computing resource(s) 410 can include one or more processors, for instance, central processing units (CPUs). Also, the processor(s) can include functional components used in the integration of program code, such as functional components to fetch program code from locations in such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s) or a computer system(s) which can implement one or more aspects disclosed herein are described further herein with reference to FIG. 3, as well as with reference to FIGS. 8A-10

As noted, program code 412 executes, in one implementation, a cognitive engine 414 which includes one or more machine-learning agents 416 that facilitate training one or more machine-learning models 418. The machine-learning models are trained using training data that can include a variety of types of data, depending on the model and the data sources. In one or more embodiments, program code 412 executing on one or more computing resources 410 applies machine-learning algorithms of machine-learning agent 416 to generate and train the model(s), which the program code then utilizes to determine, for instance, carbon logistics costs for items, and depending on the application, to perform an action (e.g., provide a solution, make a recommendation, perform a task, etc.). In an initialization or learning stage, program code 412 trains one or more machine-learning models 418 using obtained training data that can include, in one or more embodiments, network communication-related data associated with communications between servers of a network of a computing environment, such as described herein.

By way of further example, machine-learning training system can be utilized to perform machine-learning, such as described herein. Training data used to train the model (in embodiments of the present invention) can include a variety of types of data, such as data generated by one or more computer systems, network devices, etc., in communication with the computing resource(s). Program code, in embodiments of the present invention, can perform machine-learning analysis to generate data structures, including algorithms utilized by the program code to determine, for instance, carbon logistics costs for items, and/or perform a machine-learning action. As known, machine-learning (ML) solves problems that cannot be solved by numerical means alone. In one ML-based example, program code extracts features/attributes from training data, which can be stored in memory or one or more databases. The extracted features are utilized to develop a predictor function, h(x), also referred to as a hypothesis, which the program code utilizes as a machine-learning model. In identifying a machine-learning model, various techniques can be used to select features (elements, patterns, attributes, etc.), including but not limited to, diffusion mapping, principle component analysis, recursive feature elimination (a brute force approach to selecting features), and/or a random forest, to select the attributes related to the particular model. Program code can utilize a machine-learning algorithm to train a machine-learning model (e.g., the algorithms utilized by program code), including providing weights for conclusions, so that the program code can train any predictor or performance functions included in the machine-learning model. The conclusions can be evaluated by a quality metric. By selecting a diverse set of training data, the program code trains the machine-learning model 440 to identify and weight various attributes (e.g., features, patterns) that correlate to enhanced performance of the machine-learned model.

Some embodiments of the present invention can utilize IBM Watson as learning agent. IBM Watson® is a registered trademark of International Business Machines Corporation, Armonk, N.Y., USA. In embodiments of the present invention, the respective program code can interface with IBM Watson® application program interfaces (APIs) to perform machine-learning analysis of obtained data. In some embodiments of the present invention, the respective program code can interface with the application programming interfaces (APIs) that are part of a known machine-learning agent, such as the IBM Watson® application programming interface (API), a product of International Business Machines Corporation, to determine impacts of data on the machine-learning model, and to update the model, accordingly.

In some embodiments of the present invention, the program code utilizes a neural network to analyze training data and/or collected data to generate an operational model or machine-learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present invention, can utilize in implementing a machine-learning model, such as described herein.

By way of further example, FIG. 5 depicts one embodiment of a workflow 500 implemented by, or using, a data-analysis-based carbon cost logistics system, in accordance with one or more aspects of the present invention.

Referring to FIG. 5, as part of the workflow, the system receives a request to obtain an item 502 along with, in one embodiment, an item manufacturer/model based on, for instance, acquisition price 504. In one example, the carbon logistics engine (CLE) of the logistics system generates a list of one or more possible substitute items for delivery, such that the CLE has multiple items to compare 506. The CLE determines, in one embodiment, availability and warehouse locations for each of the items 508. This can include the CLE electronically communicating with one or more vendors or manufacturers for item availability and warehouse locations for each possible item of the multiple items on the list. The carbon logistics engine determines, via data-analysis, distance from the warehouses to, for instance, an end-user, including elevation data to determine carbon delivery costs 510. For instance, in one embodiment, “last-mile” or “end-user delivery” carbon cost can be determined by the carbon logistics engine (CLE) using data representative of item size, item weight, shipping distance, traffic history for shipping route, weather anticipated during shipping of item, shipping modality, etc., 512. The carbon logistics engine (CLE) further determines (in one embodiment) carbon logistics cost from, for instance, each identified manufacturer, to a respective warehouse, and from the respective warehouse to the end-user including, for instance, analyzing data for shipping distance, modality, distribution network, distribution modality, fuel types, power generation, etc., 514. In one embodiment, the carbon logistics engine (CLE) determines total carbon logistics cost for each item for delivery to the end-user 516. In one or more implementations, the carbon logistics engine (CLE) uses user-specified constraints to determine which item(s) will, for instance, meet the constraint(s), such as arriving at a user-specified location by a desired date 518. The carbon logistics engine determines if the lowest carbon cost item meets the user-specified constraint(s) 520, and if “yes”, then the lowest carbon cost item is obtained (e.g., automatically ordered, such as via a purchasing system) 522.

Based on the carbon logistics engine determining that the lowest carbon cost item does not meet one or more user-specified constraints, then in one or more embodiments, the carbon logistics engine (CLE) initiates ordering of a least-carbon logistics cost item of the multiple items, which does meet the user-specified constraint(s), and determines a carbon cost difference between the selected item and the overall least-carbon logistics cost item 524. In one embodiment, the item is obtained (for instance, automatically ordered via a purchasing system) 526, and the carbon logistics engine (CLE) recommends and/or initiates purchase of an amount of carbon offset credits equal to the carbon cost delta between the selected item and the least-carbon cost item 528.

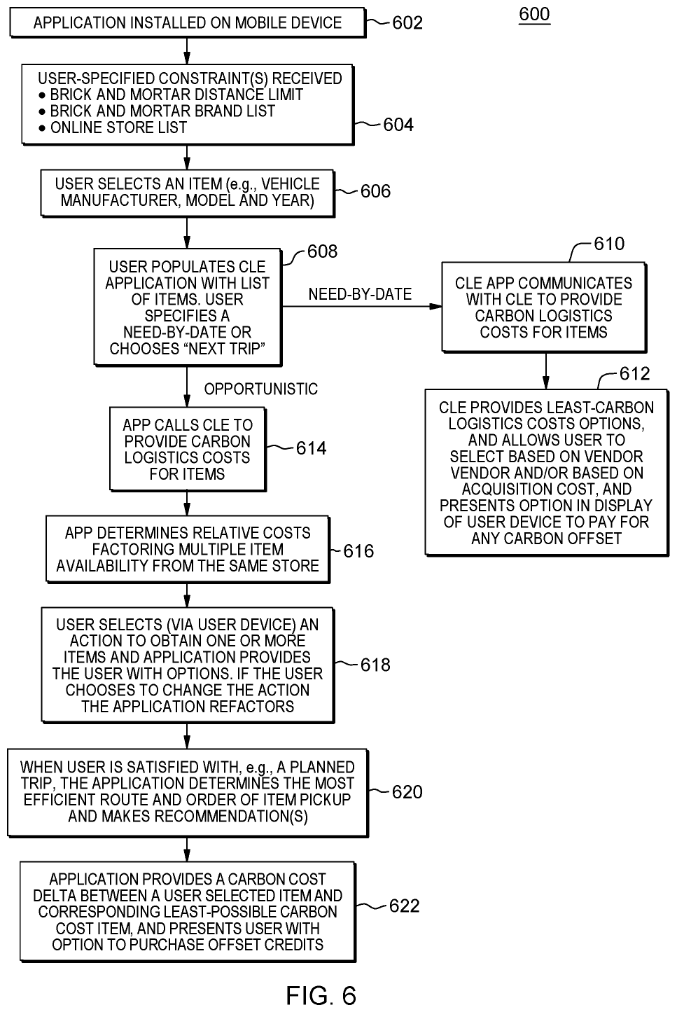

FIG. 6 illustrates another example of a workflow 600, depicting certain aspects of one or more embodiments of the present invention.

Referring to FIG. 6, workflow 600 is an example of an end-user mobile application (APP) being used in combination with, for instance, a remote carbon cost logistics system, such as a cloud-based system. The carbon cost application is installed on the mobile device 602, and one or more user-specified constraints are received 604. The constraint(s) can be, in one embodiment, for obtaining a specific item, or can be general constraint(s) used in obtaining multiple items. In one embodiment, the constraint(s) can include, for instance, brick-and-mortar store distance limits, a list of acceptable brick-and-mortar brands, an online store list, a required delivery date and/or time, etc. In one embodiment, the system receives user input of a selected item such as, for instance, a vehicle desired, including manufacturer, model, year, etc., 606. In one embodiment, the selected item can be received into the system via the user's mobile device with the application installed. In a further embodiment, the user can populate the carbon logistics engine interface application with a list of items, along with user-specified need-by-date(s), or input to obtain the item at a next opportunity 608. Assuming that the system receives user input representative of a need-by-date condition, the carbon logistics engine interface application (APP) communicates with the carbon logistics engine (CLE) to obtain from the engine and provide the user with carbon logistics costs for one or more items 610. In one embodiment, the carbon logistics engine can provide one or more least-carbon logistics cost options, and allow the user to select based on vendor and/or acquisition costs, as well as presenting options in the user's mobile device display to, for instance, pay for any carbon offset 612.

Assuming that the logistics system receives an indication that the items are to be treated as opportunistic, then, in one embodiment, the application (APP) interface communicates with the carbon logistics engine (CLE) to provide carbon logistics cost for the items identified 614. In one embodiment, the logistics system via, for instance, the application (APP) interface, can determine relative cost, factoring in multiple item availability from a same location, store, etc., 616. The user selects (for instance, via providing input using the user device) an action to obtain one or more items, and the application (APP) interface provides the user with options. If the user chooses to change the action, then the carbon logistics engine refactors the carbon logistics cost for the items 618. Based on the user being satisfied with, for instance, a planned trip to obtain one or more items, the logistics system, via the application interface, can determine, in one embodiment, a most-efficient route and order of item pickup, and can automatically provide electronic recommendations to the user's device via the application interface 620. In one implementation, the carbon cost logistics system can provide, for instance, via the application interface, a carbon cost delta between a user-selected item and a corresponding least-possible-carbon cost item of multiple items considered by the system, and present the user with an option to electronically obtain the corresponding offset carbon credits 622.

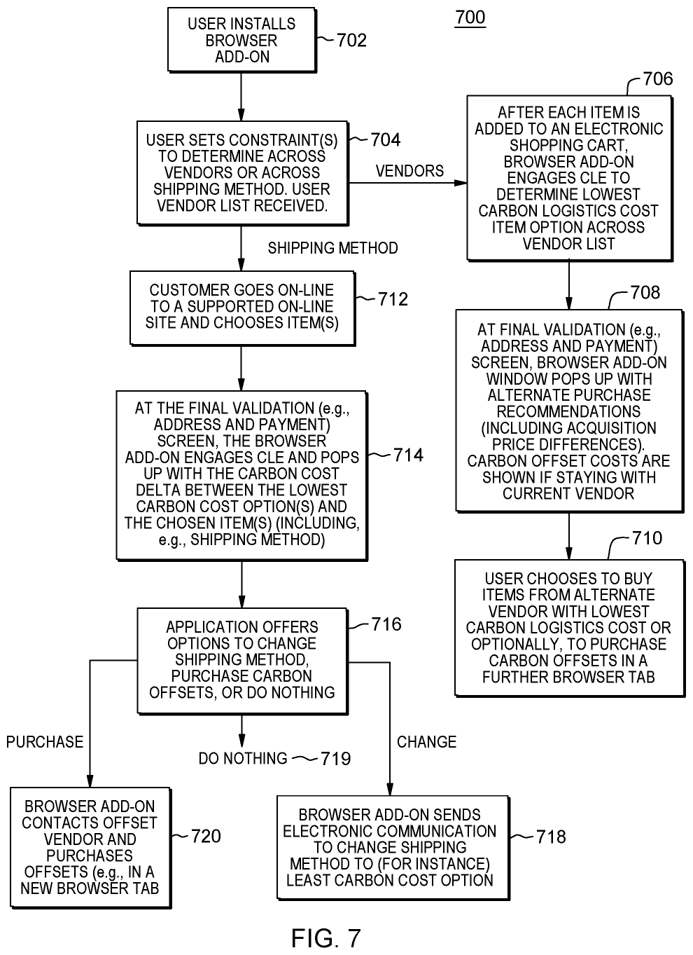

FIG. 7 depicts a further embodiment of a workflow, generally denoted 700, illustrating additional aspects of one or more embodiments of the present invention.

As illustrated in FIG. 7, workflow 700 includes, in one embodiment, a user installing a browser add-on on the user's computing device or system 702, which acts as an interface between the user's device and the carbon cost logistics system, which as noted, can be a remotely-implemented system, such as a cloud-based system. In one embodiment, the user provides an input setting one or more constraints for the logistics system to determine carbon costs across vendors and/or across shipping methods. A user vendor-approved list can also be received into the system 704. Assuming that the carbon cost logistics system is to identify items based on vendors, then (for instance) as each identified item is added to an electronic cart, the browser add-on can automatically communicate with the carbon logistics engine (CLE) to determine a lowest carbon logistics cost item option across the received or approved vendor list 706. In one example, at final validation (e.g., at an address and/or payment window), a browser add-on window can pop-up on the user's device or computer system with alternate purchase recommendations including, in one embodiment, acquisition price differences, as well as a carbon offset costs for each item when staying with, for instance, a user-selected vendor 708 as opposed to a vendor offering a lowest carbon cost item on the list of items. Further, the carbon cost logistics system allows a user to, for instance, buy an item from an alternate vendor on the list with a lowest carbon logistics cost, or optionally, to purchase carbon offsets via the further browser tab of the logistics system 710.

Where the user constrains the carbon cost logistics system based on shipping method, then, in one embodiment, the customer can electronically access, for instance, a supported online shopping site and choose one or more items 712. At a final validation (e.g., address and/or payment) screen, the browser add-on can engage (i.e., electronically communicate with) the carbon logistics engine, and provide via one or more pop-up windows a carbon cost delta between the lowest carbon cost option(s) and the chosen item(s), including, for instance, the effect of different shipping methods on the carbon cost 714. In one embodiment, the application offers one or more options to change the shipping method 718, or to purchase carbon offsets 720, or to do nothing 719. Where the shipping method is changed, the browser add-on can send an electronic communication to the online vendor to change the shipping method to, for instance, a least-carbon cost option 718. Alternatively, the user can select to do nothing 719, or the user decide to proceed to obtain the selected item using the selected shipping method, in which case the browser add-on can, in one embodiment, contact an offset vendor (i.e., a carbon offset vendor) for the user and purchase offsets for the difference in carbon cost between the selected method of shipping and the lowest cost carbon method of shipping 720.

Other variations and embodiments are possible.

Another embodiment of a computing environment to incorporate and use one or more aspects of the present invention is described with reference to FIG. 8A. In this example, a computing environment 36 includes, for instance, a native central processing unit (CPU) 37, a memory 38, and one or more input/output devices and/or interfaces 39 coupled to one another via, for example, one or more buses 40 and/or other connections. As examples, computing environment 36 may include a Power® processor offered by International Business Machines Corporation, Armonk, N.Y.; an HP Superdome with Intel® processors offered by Hewlett Packard Co., Palo Alto, Calif.; and/or other machines based on architectures offered by International Business Machines Corporation, Hewlett Packard, Intel Corporation, Oracle, and/or others. PowerPC is a trademark or registered trademark of International Business Machines Corporation in at least one jurisdiction. Intel is a trademark or registered trademark of Intel Corporation or its subsidiaries in the United States and other countries.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture. For instance, emulator code 42 allows machines based on architectures other than the z/Architecture instruction set architecture, such as Power processors, HP Superdome servers or others, to emulate the z/Architecture instruction set architecture and to execute software and instructions developed based on the z/Architecture instruction set architecture.

Further details relating to emulator code 42 are described with reference to FIG. 8B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the z/Architecture instruction set architecture, but instead, are being emulated on native CPU 37, which may be, for example, an Intel processor. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native CPU 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native CPU or by using locations in memory 38. In embodiments, guest instructions 43, native instructions 46 and emulator code 42 may reside in the same memory or may be disbursed among different memory devices.

The computing environments described above are only examples of computing environments that can be used. Other environments, including but not limited to, non-partitioned environments, partitioned environments, cloud environments and/or emulated environments, may be used; embodiments are not limited to any one environment. Although various examples of computing environments are described herein, one or more aspects of the present invention may be used with many types of environments. The computing environments provided herein are only examples.

Each computing environment is capable of being configured to include one or more aspects of the present invention.

One or more aspects may relate to cloud computing.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

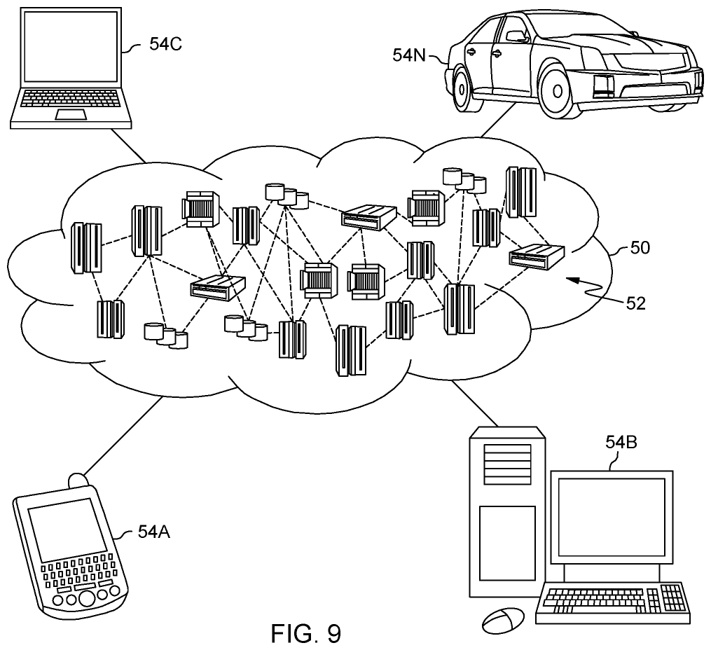

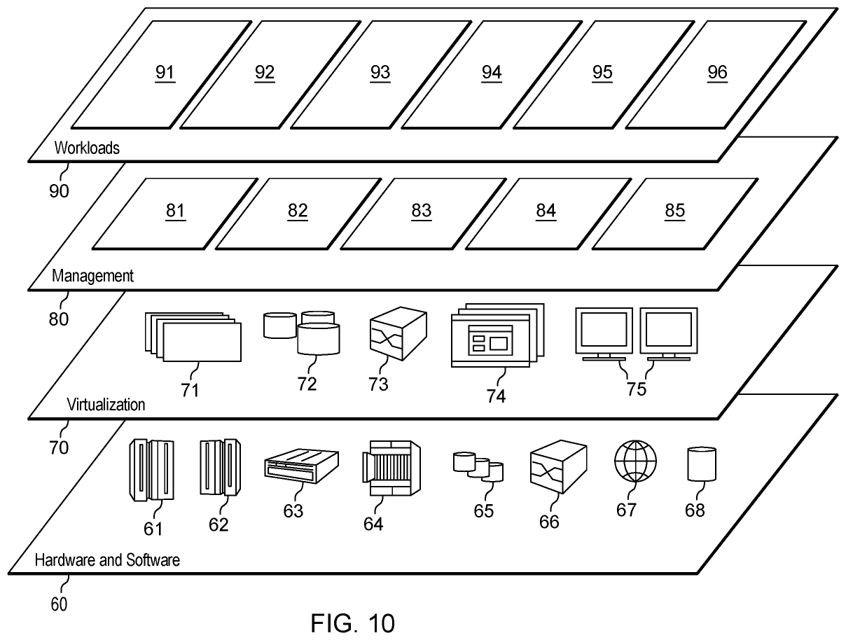

Referring now to FIG. 9, illustrative cloud computing environment 50 is depicted. As shown, cloud computing environment 50 includes one or more cloud computing nodes 52 with which local computing devices used by cloud consumers, such as, for example, personal digital assistant (PDA) or cellular telephone 54A, desktop computer 54B, laptop computer 54C, and/or automobile computer system 54N may communicate. Nodes 52 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 52 and cloud computing environment 50 can communicate with any type of computerized device over any type of network and/or network addressable connection (e.g., using a web browser).

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and carbon logistics cost processing 96.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For instance, computing environments of other architectures can be used to incorporate and/or use one or more aspects. Further, different instructions or operations may be used. Additionally, different types of registers and/or different registers may be used. Further, other data formats, data layouts and/or data sizes may be supported. In one or more embodiments, one or more general-purpose processors, one or more special-purpose processors or a combination of general-purpose and special-purpose processors may be used. Many variations are possible.

Various aspects are described herein. Further, many variations are possible without departing from a spirit of aspects of the present invention. It should be noted that, unless otherwise inconsistent, each aspect or feature described herein, and variants thereof, may be combinable with any other aspect or feature.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
one or more computer-readable storage media having program instructions embodied therewith, the program instructions being readable by a processing circuit to cause the processing circuit to perform a method comprising:
using, by one or more processors, supply-chain-based data-analysis to determine, at least in part, a carbon logistics cost for each item of multiple items;
based on the determined carbon logistics costs, identifying, by the one or more processors, a lowest carbon logistics cost item of the multiple items;
determining, by the one or more processors, whether the lowest carbon logistics cost item of the multiple items meets one or more user-specified constraints; and
based on the lowest carbon logistics cost item meeting the user-specified constraint(s), initiating an action to obtain the lowest carbon logistics cost item.

2. The computer program product of claim 1, wherein based on the lowest carbon logistics cost item not meeting the user-specified constraint(s), the method further comprises:
determining a carbon logistics cost difference between the lowest carbon logistics cost item and a selected item of the multiple items meeting the user-specified constraint(s); and
initiating an action to obtain carbon offset credits equal to the carbon logistics cost difference between the selected item and the lowest carbon logistics cost item.

3. The computer program product of claim 1, wherein determining the carbon logistics cost for each item of the multiple items comprises using neural network processing and a Markov Decision Process to determine a respective carbon logistics cost for each item of the multiple items.

4. The computer program product of claim 3, wherein the neural network processing comprises Long Short-Term Memory (LSTM) neural network processing.

5. The computer program product of claim 3, wherein determining the carbon logistics cost for each item of the multiple items comprises iterating through each time-based logistics component of multiple ascertained time-based logistics components to determine an optimal carbon-based next logistical step in a supply chain of the item.

6. The computer program product of claim 1, further comprising identifying and including one or more items in the multiple items as potential substitute items for an initially-specified item, the initially-specified item being another item of the multiple items.

7. The computer program product of claim 6, wherein identifying the one or more items for including in the multiple items is based on receiving a user-specifying input identifying the initially-specified item.

8. The computer program product of claim 1, wherein using supply-chain-based data-analysis comprises using, at least in part, Global Positioning System (GPS) logistics data for an item of the multiple items in determining the carbon logistics cost for the item.

9. The computer program product of claim 1, wherein using supply-chain-based data-analysis comprises using, at least in part, logistics data for an item of the multiple items representative of carbon delivery cost based on item size, item weight, shipping distance, and shipping modality.

10. A computer system for facilitating processing within a computing environment, the computer system comprising:
a memory; and
a processing circuit in communication with the memory, wherein the computer system is configured to perform a method, the method comprising:
using, by one or more processors, supply-chain-based data-analysis to determine, at least in part, a carbon logistics cost for each item of multiple items;
based on the determined carbon logistics costs, identifying, by the one or more processors, a lowest carbon logistics cost item of the multiple items;
determining, by the one or more processors, whether the lowest carbon logistics cost item of the multiple items meets one or more user-specified constraints; and
based on the lowest carbon logistics cost item meeting the user-specified constraint(s), initiating an action to obtain the lowest carbon logistics cost item.

11. The computer system of claim 10, wherein based on the lowest carbon logistics cost item not meeting the user-specified constraint(s), the method further comprises:
determining a carbon logistics cost difference between the lowest carbon logistics cost item and a selected item of the multiple items meeting the user-specified constraint(s); and
initiating an action to obtain carbon offset credits equal to the carbon logistics cost difference between the selected item and the lowest carbon logistics cost item.

12. The computer system of claim 10, wherein determining the carbon logistics cost for each item of the multiple items comprises using neural network processing and a Markov Decision Process to determine a respective carbon logistics cost for each item of the multiple items.

13. The computer system of claim 12, wherein the neural network processing comprises Long Short-Term Memory (LSTM) neural network processing.

14. The computer system of claim 12, wherein determining the carbon logistics cost for each item of the multiple items comprises iterating through each time-based logistics component of multiple ascertained time-based logistics components to determine an optimal carbon-based next logistical step in a supply chain of the item.

15. The computer system of claim 10, wherein using supply-chain-based data-analysis comprises using, at least in part, Global Positioning System (GPS) logistics data for an item of the multiple items in determining the carbon logistics cost for the item.

16. The computer system of claim 10, wherein using supply-chain-based data-analysis comprises using, at least in part, logistics data for an item of the multiple items representative of carbon delivery cost based on item size, item weight, shipping distance, and shipping modality.

17. A computer-implemented method comprising:
using, by one or more processors, supply-chain-based data-analysis to determine, at least in part, a carbon logistics cost for each item of multiple items;
based on the determined carbon logistics costs, identifying, by the one or more processors, a lowest carbon logistics cost item of the multiple items;
determining, by the one or more processors, whether the lowest carbon logistics cost item of the multiple items meets one or more user-specified constraints; and
based on the lowest carbon logistics cost item meeting the user-specified constraint(s), initiating an action to obtain the lowest carbon logistics cost item.

18. The computer-implemented method of claim 17, wherein based on the lowest carbon logistics cost item not meeting the user-specified constraint(s), the computer-implemented method further comprises:
determining a carbon logistics cost difference between the lowest carbon logistics cost item and a selected item of the multiple items meeting the user-specified constraint(s); and
initiating an action to obtain carbon offset credits equal to the carbon logistics cost difference between the selected item and the lowest carbon logistics cost item.

19. The computer-implemented method of claim 17, wherein determining the carbon logistics cost for each item of the multiple items comprises using neural network processing and a Markov Decision Process to determine a respective carbon logistics cost for each item of the multiple items.

20. The computer-implemented method of claim 19, wherein the neural network processing comprises Long Short-Term Memory (LSTM) neural network processing.
